(19) United States
(12) Patent Application Publication
(10) Pub. No.: US 2005/0188359 A1
(43) Pub. Date: Aug. 25, 2005

(54) Method and computer program product for developing and directing simulations

(76) Inventors: Tom Lalor, North Vancouver (CA); Chia-Chen Tsai, Surrey (CA); Chang-Yu Chen, Surrey (CA)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 10/783,928

(22) Filed: Feb. 20, 2004

(51) Int. Cl. G06F 9/45

(52) U.S. Cl. 717/136

(57) ABSTRACT

A method and a computer program product for developing and directing simulations used to train humans and animals in the development of various skills. The computer program product provides for selection of multiple locations within a defined area on a display screen, creation of one or more high level computer instructions describing the simulation relative to said locations and translation of the high level computer instructions into low level computer executable instructions necessary to carry out execution of the simulation. The high level computer instructions can be entered manually, or created automatically following selection of a high level command combined with a high level action. The resulting high level instructions can be downloaded to an external portable device for convenient display of the simulation at a remote location. The external device may be a remote control device that is capable of displaying simulations and controlling multiple electronic training devices.

### FIELD OF THE INVENTION

The present invention relates generally to a method and a computer program product for developing and directing simulations used to train humans and animals in the development of various skills. In particular the method and computer program product relate to developing and directing animated simulations of exercises used to train animals and animal trainers, such as hunting and retrieving dogs and their trainers. The invention also relates to a remote control device for controlling one or more electronic training devices and for displaying animated simulations.

### BACKGROUND

Animals, such as hunting and retrieving dogs, and their trainers may train together in a variety of ways. One method of training is to prepare simulations duplicating situations that might occur in an actual live hunting scenario, or in a competitive trial. For example, one or more dummy birds may be thrown or launched into the water, gun shots may be sounded, hand signals or verbal commands may be given, and the dog may be instructed to retrieve the birds. It may take hundreds of such simulations and various behaviour corrections to achieve championship performance. Junior trainers must learn the simulations, including the various terrain setups on water, land or both, and the various corrections required if the dog makes an error.

The design of such simulations has been the subject of many articles, books and videos prepared by professional trainers. However, simulations that appear in written articles, books and videos are difficult and/or expensive to prepare and are awkward to transport and reference in the field with the trainer and his dog. Moreover, it is difficult for the trainer to modify the simulations and to record the modifications for future reference. Finally, there is no easy system that the trainer can use to develop and record such training simulations for reference at a later time in the field while training with the dog.

It would therefore be advantageous to develop a method and a computer program product that overcomes the disadvantages of the prior art and can be used to develop and direct simulations of exercises used to train animals, such as hunting and retrieving dogs, and their trainers. It would be further advantageous if these simulations could be downloaded to and stored for execution on a remote device that could be easily transported to the actual training environment and easily referenced by the trainer while training with his animal. It would also be advantageous if this remote device could be used to both execute and display training simulations and as a remote control device to operate other electronic devices, such as electronic animal training collars, anti-bark collars, remote projectile launchers, animal containment systems, remote bird release devices, or any other remote training device. It would be advantageous if the method and computer program product could be used by the average animal trainer having no knowledge of complicated computer programming code to develop and display such simulations on a display screen, using only a simple high level program script. It would be further advantageous if the method and computer program product could be used to develop and display simulations in other sports such as hockey or football to provide players with an animated visual simulation of designed plays.

### BRIEF SUMMARY

It is an object of one aspect of the applicant's method and computer program product to overcome disadvantages of the prior art.

According to one aspect, there is provided a computer program product for developing and directing a simulation displayable on a display screen, the computer program product embodied on a computer usable medium comprising: computer readable program code configured to: provide for selection of multiple locations within a defined area on the display screen; provide for creation of one or more high level computer instructions describing the simulation relative to said locations; provide for translation of the one or more high level computer instructions into low level computer executable instructions necessary to carry out execution of the simulation.

According to another aspect, there is provided a computer program product for directing a simulation displayable on a display screen, the computer program product embodied on a computer usable medium comprising: computer readable program code configured to: provide for selection of multiple locations within a defined area on the display screen; provide for automatic creation of one or more high level computer instructions describing the simulation relative to said locations following selection of one or more high level commands from a high level command area on the display screen and one or more high level actions from a high level action area on the display screen; provide for translation of the one or more high level computer instructions into low level computer executable instructions necessary to carry out execution of the simulation.

According to a further aspect, there is also provided a method for developing and directing a simulation displayable on a display screen comprising the steps of: running a computer program product on a computer connected to the display screen, the computer program product designed for developing and directing simulations; using the computer program product to select multiple locations within a defined area on the display screen; using the computer program product to select one or more high level commands from a high level command area on the display screen; using the computer program product to select one or more high level actions from a high level action area on the display screen; and using the computer program product to automatically combine the selected one or more high level commands and the selected one or more high level actions to create one or more high level computer instructions describing the simulation relative to said locations.

One advantage of the applicant's method and computer program product is that it facilitates the development and directing of animated simulations of many different kinds of exercises and events, which can be used as training aids in many situations, to train both animals and humans. A further advantage is that it can be downloaded to and stored for execution on an external device, such as a portable handheld device, which can be transported into the field for easy reference during the training process. Yet another advantage is that the portable handheld device can be used to both execute and display training simulations and as a remote control device to operate other electronic devices such as electronic animal training collars, anti-bark collars, remote projectile launchers, animal containment systems, remote bird release devices, or any other remote training device. Another advantage is that it can be used by the average trainer having no knowledge of complicated computer programming code to develop and display training simulations on a display screen, using only a simple high level programming script.

Further objects and advantages will be apparent from the following description, wherein various embodiments are clearly described and shown.

### BRIEF DESCRIPTION OF THE DRAWINGS

In drawings that illustrate the applicant's method and computer program product by way of example:

FIG. 1 is a view of a display screen generated by one embodiment of the computer program product prior to assignment of initial variable locations.

FIG. 2 is a view of a display screen generated by one embodiment of the computer program product during design of the simulation and preparation of the high level computer instructions.

FIG. 3 is another view of a display screen generated by one embodiment of the computer program product during design of the simulation and preparation of the high level computer instructions.

FIG. 4 is yet another view of a display screen generated by one embodiment of the computer program product during design of the simulation and preparation of the high level computer instructions.

FIG. 5 is a view of a display screen generated by one embodiment of the computer program product during execution of a simulation.

FIG. 6 is a view of a display screen generated by one embodiment of the computer program product showing the assignment of initial variable locations and an imported image.

FIG. 7 is a flow chart showing the steps in a method of operating one embodiment of the computer program product.

FIG. 8 is a view showing a portable handheld controller device used to both execute and display training simulations and to control other remote training devices.

Corresponding reference numerals indicate corresponding parts throughout the various figures.

### DETAILED DESCRIPTION

The present method and computer program product will be described in relation to its use in developing and directing simulations to train animals, such as hunting and retrieving dogs, and their trainers, however, it will be understood by those skilled in the art that the method and computer program product describe herein can be easily modified and adapted to develop and display animated simulations of many common activities involving the movements of objects between designated locations, such as for example in the development and display of specific plays in hockey or football, or other sports.

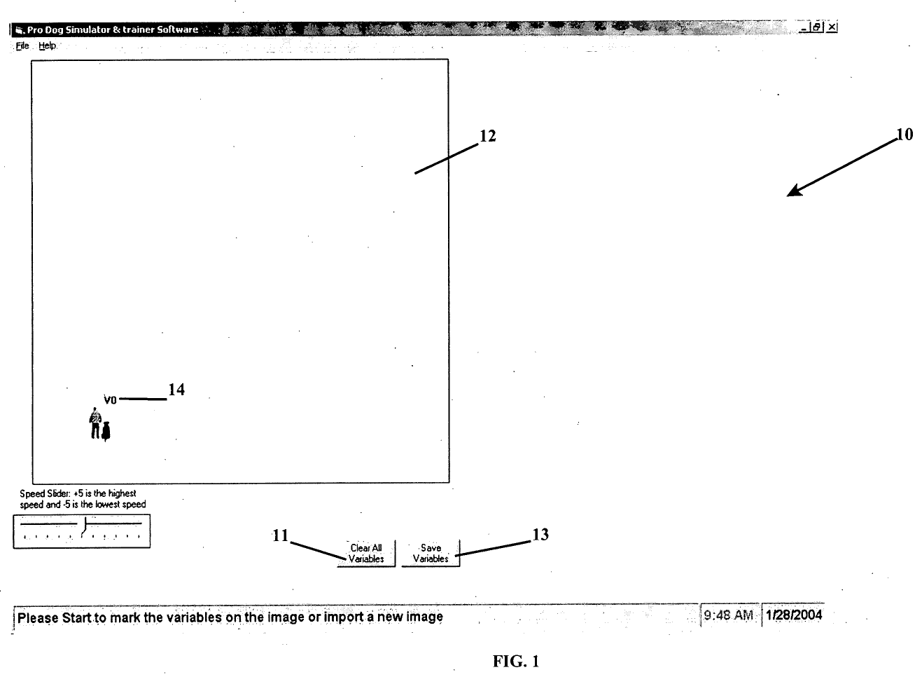

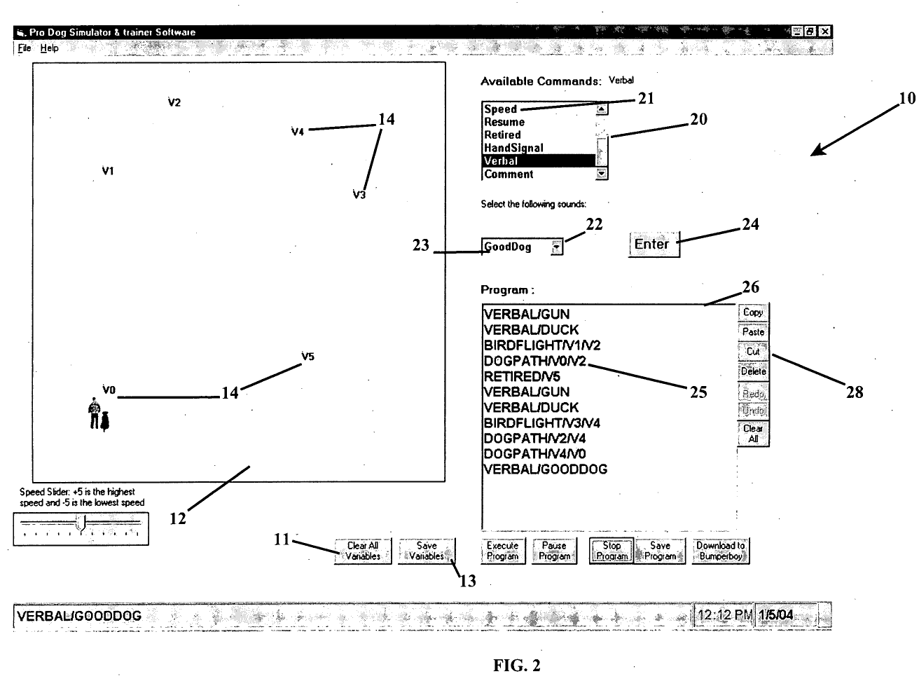

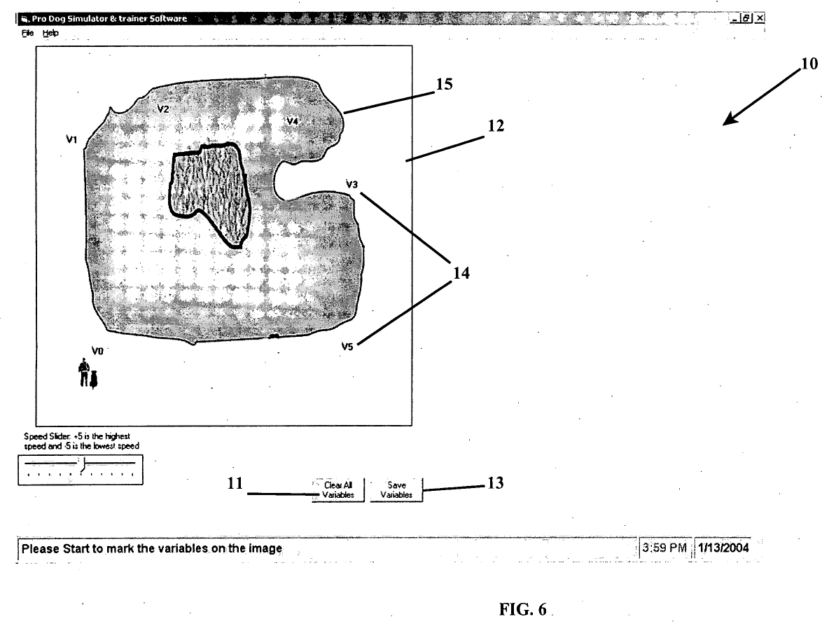

FIG. 1, illustrates an initial view generated by the present computer program product on a computer display screen 10, showing a defined area 12 in which variable locations 14 can be designated by mouse-clicking at any desired point or, alternatively, by drawing a line or curve within defined area 12, the variable locations 14 being automatically generated as multiple points along the line or curve. FIG. 2 shows six variable locations 14, V0 to V5, specified within area 12. Variable locations 14 represent points of interest within defined area 12, which can be assigned object character, and between which various object movement tasks can be specified. As illustrated in FIG. 6, a landscape image or images 15 can be imported into defined area 12 to illustrate a desired hunting terrain, or a playing field. In the illustrated case, landscape image 15 is an image of a hunting area, including a pond with water and an island. Variable locations 14 can be superimposed over landscape image 15 providing proper reference points and giving the simulation a more realistic appearance.

Once variable locations 14 are determined, they are saved using a “save variables” button 13. At that point, display screen 10 changes to include a command area 20, an action area 22, an “enter” button 24, and a high level program area 26 (see FIG. 2). If the assigned variable locations 14 are unacceptable, they can be cleared before saving, using a “clear all variables” button 11 and the variable locations 14 can be re- selected.

In one embodiment of the present computer program product, command area 20 includes high level commands 21 such as:
BirdFlight
DogPath
HandlerPath
Delay
Speed
Resume
Retired
HandSignal
Verbal
Audio
Comment
   However, it will be understood by those skilled in the art that command area 20 can include any number of high level commands 21 deemed desirable and necessary depending on the nature of the simulation or training concept being illustrated. For example, if a simulation is being developed to illustrate a particular play in hockey, high level commands 21 such as “PuckPath” and “PlayerPath” might be included, along with other suitable high level commands related to simulation of hockey plays.

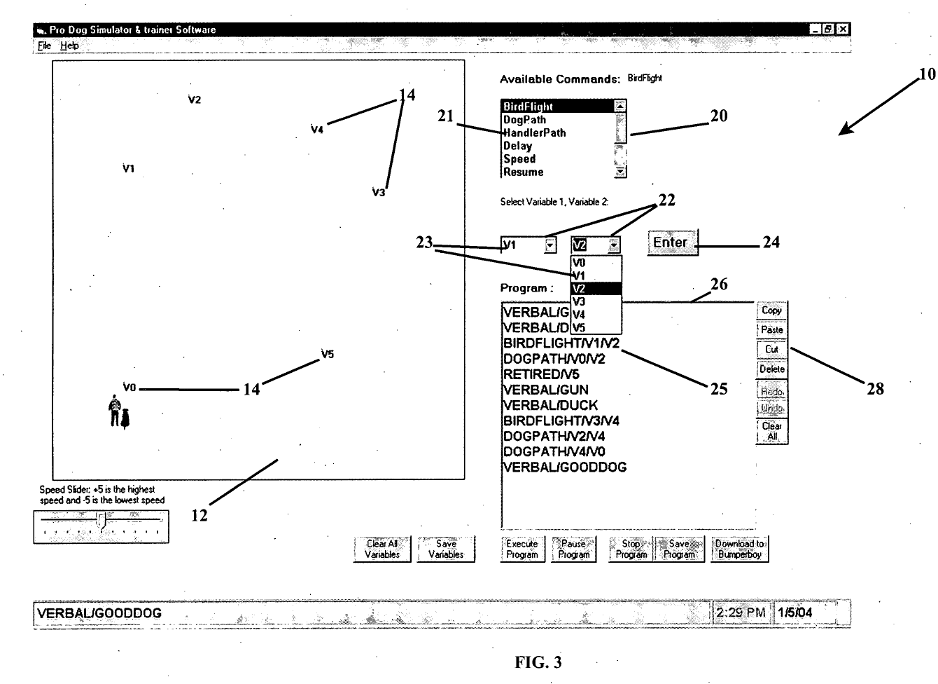

Action area 22 contains various high level actions 23 that can be selected and assigned to the selected high level commands 21 from command area 20. The actions available from action area 22 will depend on which high level command 21 is selected from high level command area 20. For example, if the high level command “BirdFlight” is selected, action area 22 is modified to provide two drop-down menus requesting two variable locations 14 to be selected and assigned to the high level command “BirdFlight” (see FIG. 3). Once the enter button 24 is clicked, a high level computer instruction 25, in this case “BirdFlight/V1/V2”, is generated and displayed on a separate line in high level program area 26.

Therefore, by selecting high level command 21 from command area 20 and combining it with high level action 23 from action area 22, the corresponding high level computer instruction 25 is generated automatically in high level program area 26 to describe one segment of the desired simulation. In this case, the high level computer instruction “BirdFlight/V1/V2” assigns an object character instruction, “bird”, to variable location, “V1”, and then assigns an object movement instruction between two variable locations, “V1” and “V2”. If the high level command “DogPath” or “HandlerPath” is selected, a movement instruction could be assigned from action area 22 to describe movement of the dog or the handler between two variable locations 14 within defined area 12.

It will be appreciated that any necessary number of high level commands 21 could be located in high level command area 20 and combined with any number of desired high level actions 23 from action area 22 to generate any combination of high level computer instructions 25 in high level program area 26 corresponding to the desired animated simulation.

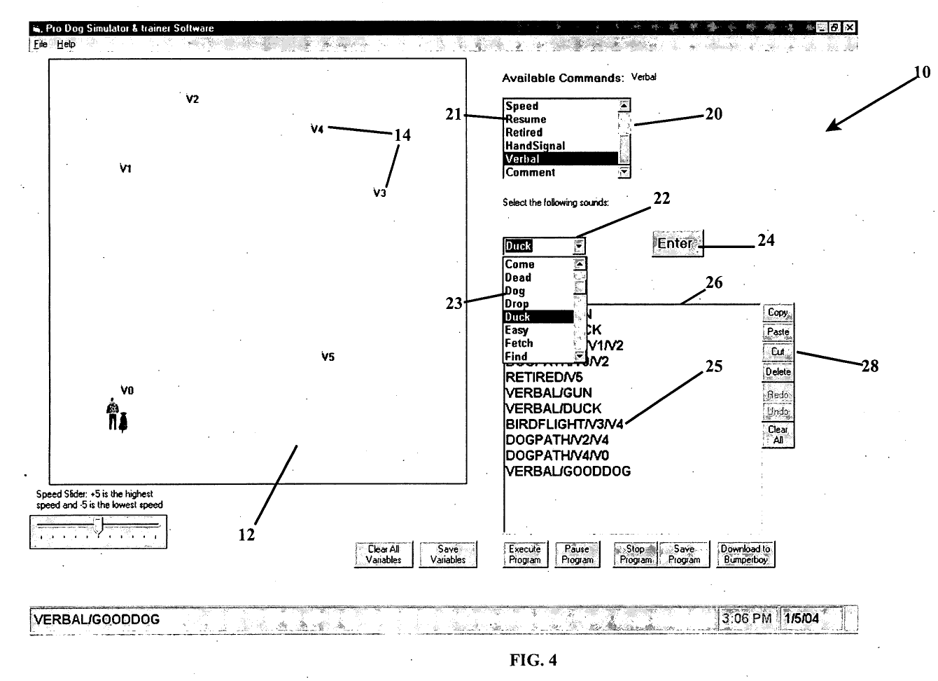

In another example, as shown in FIG. 4, when high level commands 21 such as “Verbal” or “Audio” are selected from command area 20, action area 22 is modified to provide a drop-down menu of high level actions 23 to permit the selection of a predetermined sound or audio clip, thus creating high level computer instructions 25 required to play sound or prerecorded audio in the simulation. The sound or audio selection may include any sound required by the simulation. In the presently described embodiment, sound may include duck calls or gun shots, verbal commands such as “come”, “good dog”, “heel”, “OK” and the like, whistle sounds, and buzzer sounds, etc. Audio may include various prerecorded MP3 or WAV files, or any other suitable audio format. The “Verbal” or “Audio” commands can be used to add realism to the simulation, such as for example by adding a duck call sound during the bird flight or gun shots, or they can be used to describe an action that should be taken by the trainer during the simulation, such as for example to give the verbal reward “good dog”. “Verbal” or “Audio” commands can also be used to describe an action that the trainer must take to correct a bad behaviour. For example, the verbal action “nick” can be used to indicate to the trainer that he should give the dog a corrective electrical shock using a remote electric shock device attached to a dog collar fixed to the dog's neck. Prerecorded audio can be inserted during display of the animated simulation to provide further explanation regarding the training simulation.

A high level command 21 such as “Comments” can be used to generate high level computer instructions 25 to include descriptive text in the simulation display to provide further explanation regarding the training simulation. Notes and images can also be added to provide additional explanation and produce a slide show effect in the simulation display.

Other high level commands 21 such as “Delay”, “Speed” and “Resume” can be used to generate high level computer instructions 25 to control operation of the simulation. As before, when high level commands 21 are selected from command area 20, action area 22 is modified to provide a drop-down menu to permit the selection of corresponding high level actions 23. The high level command “Delay” may be combined with corresponding high level action 23 to specify the number of seconds the simulation is to pause. For example, the high level instruction “Delay2”, would indicate a two second pause. The high level command “Speed” can be combined with corresponding high level action 23 to specify a percentage, plus or minus, of normal speed. For example, the high level instruction “Speed+2”, would indicate that the speed is to be increased to two times normal speed.

High level commands 21 such as “Retired” and “HandSignal” can be combined with appropriate high level actions 23 to generate high level computer instructions 25 required to insert secondary images into the simulation. For example, such commands can be used to place a retired gunner at a specified variable location 14 or to cause the illustration of a particular hand signal that the trainer should give to the dog.

It will be appreciated by those skilled in the art that the high level computer instructions 25 generated by the present computer program product and displayed in the high level program area 26 correspond to a series of low level computer executable instructions required to carry out the simulation. The low level computer executable instructions can be written in low level computer languages such as Visual C++™, Visual Basic™, Assembler, or other suitable computer languages, such as Flash™ Animation developed by MacroMedia Inc.

In the present computer program product, variable locations 14 are used to locate and direct the animated simulation through generation of high level computer instructions 25 that correspond to ordinary language. The high level computer instructions 25 are automatically generated by the present computer program product upon selection of high level commands 21 from command area 20 and high level actions 23 from action area 22, requiring little or no programming skill by the user. This differs from existing animation programs such as Flash™ Animation, which use images, time frames and positions, and require a high degree of computer programming skill to create animated simulations.

The following is an example of a typical high level computer instruction 25 generated by the applicant's computer program product, and the corresponding low level computer executable instructions required to carry out the corresponding animation on the display screen:

High level computer instruction 25:

DOGPATH/V0/V1
   Corresponding low level computer executable instructions:
//To Identify this line command is the DOGPATH

Call Command_Parse(LineString) ‘Call Command_Parse function to identify the line command

```
// Get the pixel Values of the Start Variable and the End Variable.
‘ dogpath ----------------------------------------------------------------------------
    If Left$(strArray$(j%), 7) = “DOGPATH” Then
      cmd = 2
        Start_vb = Mid$(strArray$(j%), 8, 4)
        Call Start_var(Start_vb)
        If Start_flag = ERROR Then
            Call Error_Handle( ) ‘Error handle function to show the error message
            Stop_Program  ‘ Stop program and show the high-light on the error
line
        End If
          Call End_var(Endvariable) ‘ check end var
          If End_flag = −1 Then
                Call Error_Handle( ) ‘Error handle function to show the error
message.
                Stop_Program  ‘ Stop program and show the high-light on
                the error line
          End If
    End If
// Add the dog on the variable:
  If ((StartX = −1 Or StartY = −1 Or EndX = −1 Or EndY = −1) Or ERROR1 = 1) And Test_mode%
= 1 Then
            Call Error_Handle( ) ‘Error handle function to show the error message.
            Stop_Program  ‘ Stop program and show the high-light on the error
line
  Else
  If (StartY = EndY And StartX = EndX) Then
    If Test_mode% = 0 Then
          Dog_No(Start_index) = Dog_No(Start_index) + 1 ‘* Test_mode%
    End If
  Else
    If Test_mode% = 1 Then
    X1 = StartX
    X2 = EndX
    Y1 = StartY
    Y2 = EndY
    Final.DrawStyle = 2
    Final.DrawWidth = 1
      Final_BG2.DrawStyle = 2
      Final_BG2.DrawWidth = 1
    Final.Line (X1, Y1)−(X2, Y2), RGB(255, 0, 0)
    Final_BG2.Line (X1, Y1 )−(X2, Y2), RGB(255, 0, 0)
    If Dog_No(Start_index) > 0 Then ‘delete the start dog
      Dog_No(Start_index) = Dog_No(Start_index) − 1
    End If
    Timer3.Enabled = True
    Do
      DoEvents
    Loop While Stop2 = 0
    Dog_No(End_index) = Dog_No(End_index) + 1
    PIC_REFLASH
    Stop2 = 0
  End If
End If
// Re-flash the whole picture when any picture is changed
Private Sub PIC_REFLASH( )
    Dim indx As Integer
  Dim Result As Long
    ‘Final.Picture = Final_BG2.Picture
    Result = BitBlt(Final.hDC, 0, 0, Final.Width, Final.Height, Final_BG2.hDC, 0, 0,
vbSrcCopy)
    Final.Picture = Final.Image
    ‘Final.PaintPicture Final_BG2.Picture, 0, 0, 512, 512, 0, 0, 512, 512, &HCC0020
    ‘reflash dog
    For indx = 0 To 29
      If Dog_No(indx) > 0 Then
        BitBlt Final.hDC, Vector(indx + 1, 0), Vector(indx + 1, 1), Final.Width, Final.Height,
dog_s_M.hDC, 0, 0, vbMergePaint
        BitBlt Final.hDC, Vector(indx + 1, 0), Vector(indx + 1, 1), dog_s_M.Width,
dog_s_M.Height, dog_s_F.hDC, 0, 0, vbSrcAnd
        Final.Picture = Final.Image
      End If
      If DogR_No(indx) > 0 Then
        BitBlt Final.hDC, Vector(indx + 1, 0), Vector(indx + 1, 1), Final.Width, Final.Height,
dog_rs_M.hDC, 0, 0, vbMergePaint
        BitBlt Final.hDC, Vector(indx + 1, 0), Vector(indx + 1, 1), dog_rs_M.Width,
dog_rs_M.Height, dog_rs_F.hDC, 0, 0, vbSrcAnd
        Final.Picture = Final.Image
      End If
  End Sub
// Get the Start Variable and its error message
  Private Function Start_var(str_start As String)
    Select Case str_start
          Case “/V0/”:
              Start_index = 0
              If Vector(1, 0) = −1 Or Vector(1, 1) = −1 Then
                MsgBox “Please add Variable 0!!!”
                Start_index = −1
                  Start_flag = −1
              End If
          Case “/V1/”:
              Start_index = 1
              If Vector(2, 0) = −1 Or Vector(2, 1) = −1 Then
                MsgBox “Please add Variable 1!!!”
                Start_index = −1
                  Start_flag = −1
              End If
          Case “/V2/”:
              Start_index = 2
              If Vector(3, 0) = −1 Or Vector(3, 1) = −1 Then
                MsgBox “Please add Variable 2!!!”
                Start_index = −1
                  Start_flag = −1
              End If
          Case ”/V3/”:
              Start_index = 3
              If Vector(4, 0) = −1 Or Vector(4, 1) = −1 Then
                MsgBox “Please add Variable 3!!!”
                Start_index = −1
                  Start_flag = −1
              End If
  ‘If you have 100 variables, then you must set 100 case selections.
          Case Else:
            Start_flag = −1
            Start_index = −1
          End Select
          If Start_index <> −1 Then
              StartX = Vector(Start_index + 1, 0)
              StartY = Vector(Start_index + 1, 1)
              retired_index(Start_index) = 1
            If (Start_flag And 8) Then ‘ bit8 of Start_flag_tmp for dog or no retired
                retired_index(Start_index) = 0
              End If
          End If
  End Function
// Get the End Variable and its error message
  Private Function End_var(str_end As String)
  Dim Test_mode As Integer
    If (End_flag And 128) Then
      Test_mode = 1
    End If
          Select Case str_end
          Case “/V0”:
              End_index = 0
              If Vector(1, 0) = −1 Or Vector(1, 1) = −1 Then
                MsgBox “Please add Variable 0!!!”
                End_index = −1
                End_flag = −1
              End If
          Case ”/V1”:
              End_index = 1
              If Vector(2, 0) = −1 Or Vector(2, 1) = −1 Then
                Msg Box “Please add Variable 1!!!”
                End_index = −1
                End_flag = −1
              End If
          Case “/V2”:
              End_index = 2
              If Vector(3, 0) = −1 Or Vector(3, 1) = −1 Then
                MsgBox “Please add Variable 2!!!”
                End_index = −1
                End_flag = −1
              End If
          Case “/V3”:
              End_index = 3
              If Vector(4, 0) = −1 Or Vector(4, 1) = −1 Then
                MsgBox “Please add Variable 3!!!”
                End_index = −1
                End_flag = −1
              End If
  ‘If you have 100 variables, then you must set 100 case selections.
          Case Else:
                End_flag = −1
                End_index = −1
          End Select
          If End_index <> −1 Then
              EndX = Vector(End_index + 1, 0)
              EndY = Vector(End_index + 1, 1)
          End If
End Function
```

In addition to the generation of high level computer instructions 25 in high level program area 26 through the method described above where the user selects commands and actions from command area 20 and action area 22, the applicant's computer program product permits a user to manually enter high level program instructions 25 directly into program area 26 and to delete or edit any high level program instructions 25 located in program area 26. As shown in FIGS. 2 to 5, editing buttons 28, such as “copy”, “paste”, “cut”, “delete”, “redo”, “undo” and “clear all” are located next to high level program area 26. This provides a way for the experienced user to rapidly develop high level program instructions 25 corresponding to new simulations and to edit high level program instructions 25 contained in existing simulations.

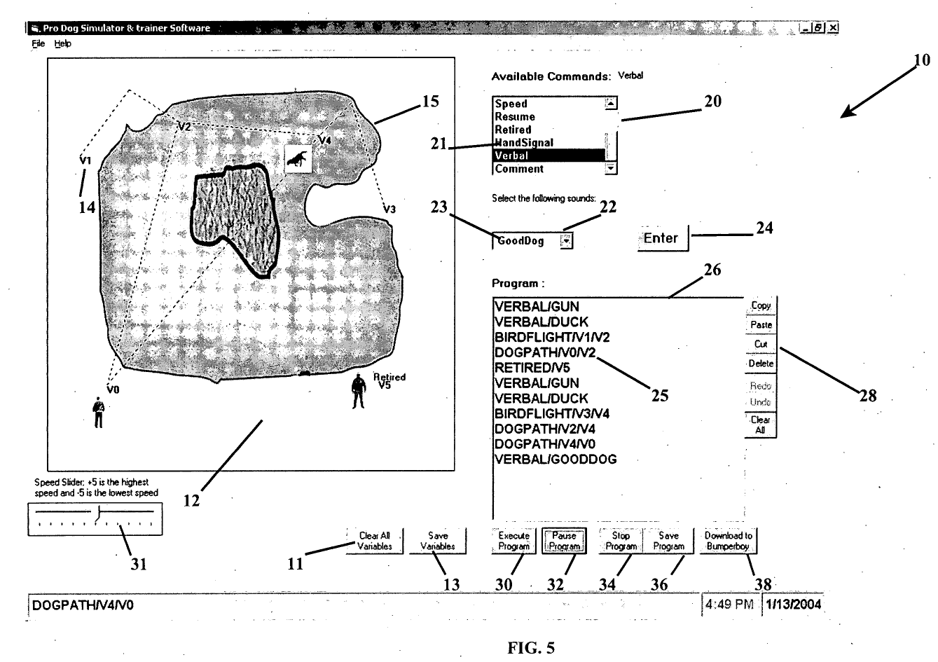

Once the desired combination of high level computer instructions 25 corresponding to the desired animated simulation is generated or entered in high level program area 26, the simulation can be executed by clicking on an “Execute Program” button 30. FIG. 5 shows one example of computer display screen 10 as it appears during execution of the animated simulation produce by the present computer program product. Dashed lines are drawn to trace the various movements executed in the simulation.

Upon execution, the present computer program product translates the high level computer instructions 25 located in program area 26 into corresponding low level computer executable instructions necessary to carry out the simulation. During execution, the user can pause or stop execution of the simulation by clicking on the corresponding “Pause Program” button 32 or “Stop Program” button 34. The speed of execution of the simulation can be controlled by a slider bar 31 located below defined area 12.

The high level program instructions 25 can be saved to a local disk drive by clicking on a “Save Program” button 36 or exported to and stored for execution on an external device, such as an external computer or a portable hand held device connected via a USB or similar port using a “Download” button 38. The external computer or portable hand held device is configured to translate the high level computer instructions 25 into corresponding low level computer executable instructions necessary to carry out the simulation on the external computer or hand held device.

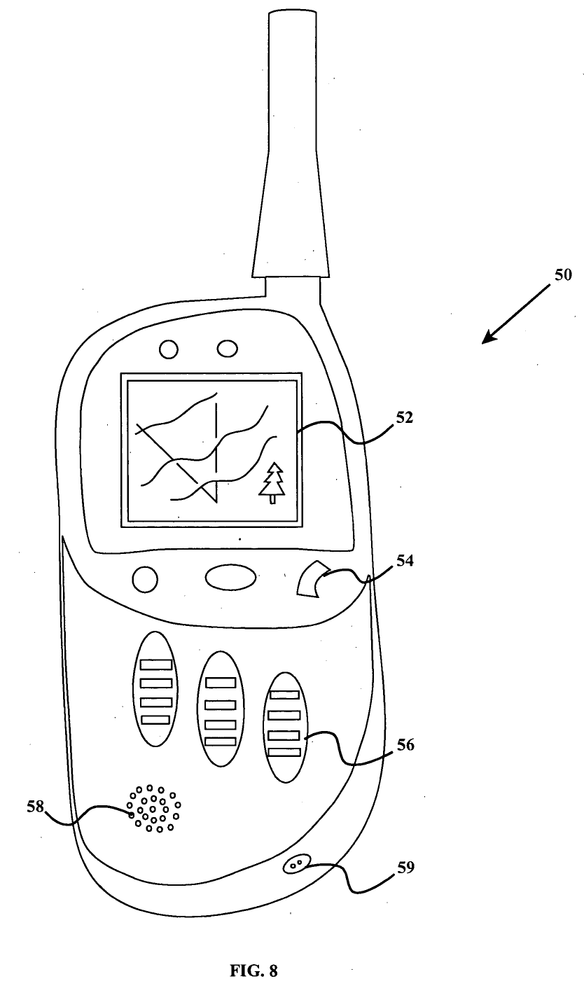

In one embodiment, the hand held device is connected to or comprises a self-contained remote hand held controller device 50, as shown in FIG. 8, which can be used to both execute and display training simulations and to control electronic animal collars, anti-bark collars, remote projectile launchers, animal containment systems, remote bird release devices, or any other remote training device. Remote controller device 50 includes a display 52 for displaying images related to the simulations or other video, a selector key 54 for selecting which of the one or more remote training devices is to be controlled, control keys 56 for entering control codes, a speaker 58, for playing sound associated with the simulations or video, and a download port 59, such as a USB port or any similar port for connecting remote controller device 50 to a computer for downloading the high level program instructions 25 corresponding to the desired simulation or for downloading video or text data. Preferably, remote hand held controller 50 is capable of downloading, executing and displaying training simulations comprising the high level program instructions 25 described by the applicant herein or other similar simulations written in any other suitable computer programming language, such as Visual C++™, Visual Basic™, Assembler, or Flash™ Animation.

One advantage of using single remote controller device 50 to control the one or more training devices and execute and display animations generated by the present computer program product or written in other suitable computer programming languages is that it permits the trainer to more easily concentrate on training rather than having to worry about keeping track of separate multiple controllers and display units. Another advantage is that software can be developed for the single controller device 50 that can be used to record certain activities during execution of the simulation by the animal and trainer. For example, the software could be use to record training statistics, such as the number of times the electronic collar was used during execution of a particular simulation to correct the animal's behaviour.

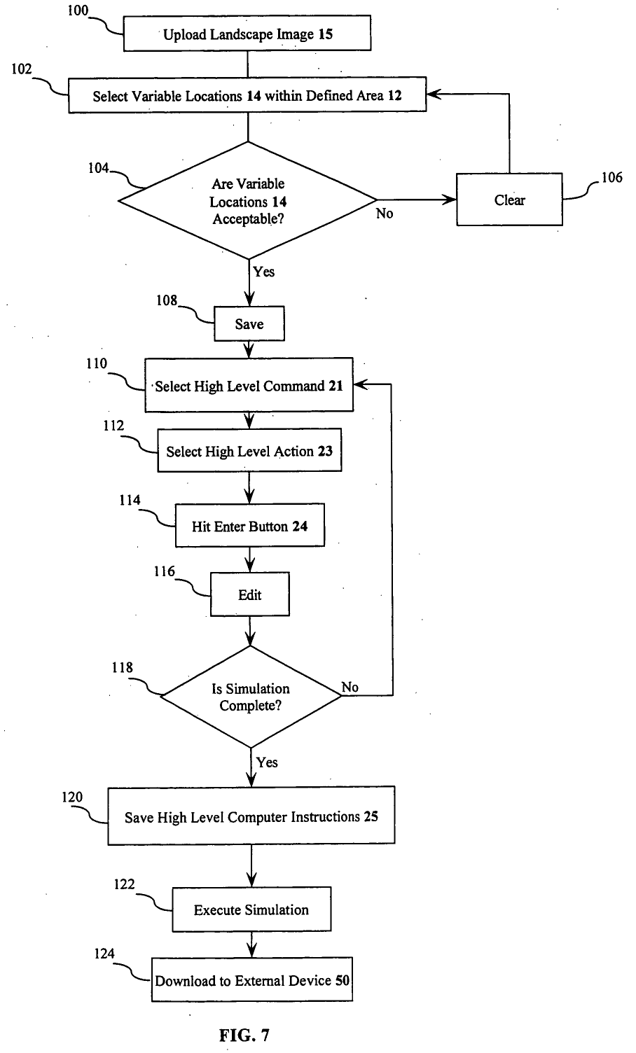

The steps in using the present computer program product to automatically generate high level computer instructions 25 corresponding to a desired simulation will now be reviewed and described with reference to FIG. 7. If desired, landscape image 15 is first uploaded into defined area 12 on display screen 10 (step 100). Variable locations 14 are selected within area 12 (step 102), by mouse-clicking on a desired point, or tracing a continuous line or curve, and the user determines whether variable locations 14 are acceptable (step 104). If not acceptable, variable locations 14 are cleared (step 106) and re- selected (step 102). If variable locations 14 are acceptable, they are saved (step 108). Once variable locations 14 have been saved, high level command 21 is selected from high level command area 20 (step 110) and combined with high level action 23 from high level action area 22 (step 112). The enter button 24 is pressed (step 114) to place high level computer instruction 25 into high level program area 26. High level computer instructions 25 can then be edited (step 116) or further high level computer instructions 25 can be manually entered into program area 26. Next the user determines whether sufficient high level computer instructions 25 have been created to complete the simulation (step 118). If the simulation is not complete, steps 110 to 118 are repeated. If the simulation is complete, it is saved (step 120) and may be executed (step 122) and downloaded to an external device (step 124).

It will be appreciated by those skilled in the art that only certain configurations of the present method and computer program product have been illustrated herein by the applicant, but that other configurations and designs, that fall within the scope of the present method and computer program product, as herein described by the applicant, are possible. It is therefore likely that the present method and computer program product may be embodied in other specific forms without departing from its spirit or essential characteristics. The present embodiments are to be considered as illustrative and not restrictive, the scope of the method and computer program product described herein being indicated by the appended claims rather than by the foregoing description, and all changes that come within the meaning and range of equivalency of the claims are therefore intended to be embraced therein.

1. A computer program product for developing and directing a simulation displayable on a display screen, the computer program product embodied on a computer usable medium, the computer program product comprising:
computer readable program code configured to:
provide for selection of multiple locations within a defined area on the display screen;
provide for creation of one or more high level computer instructions describing the simulation relative to said locations; and
provide for translation of said one or more high level computer instructions into low level computer executable instructions necessary to carry out execution of the simulation.

2. The computer program product of claim 1, wherein said creation of said one or more high level computer instructions is accomplished automatically following selection of one or more high level commands from a high level command area on the display screen and one or more high level actions from a high level action area on the display screen.

3. The computer program product of claim 1, wherein said one or more high level computer instructions describing the simulation include (a) character instructions assigning object character to one or more of said locations, and (b) movement instructions assigning object movement between two or more of said locations.

4. The computer program product of claim 1, wherein said one or more high level computer instructions describing the simulation include one or more sound instructions describing one or more sounds related to the simulation.

5. The computer program product of claim 1, wherein said one or more high level computer instructions describing the simulation include one or more speed control instructions to control the speed of said execution of the simulation.

6. The computer program product of claim 1, wherein said one or more high level computer instructions describing the simulation include one or more delay instructions to delay said execution of the simulation.

7. The computer program product of claim 1, wherein said one or more high level computer instructions describing the simulation include one or more comment instructions to insert textual comments into the simulation.

8. The computer program product of claim 1, wherein said one or more high level computer instructions describing the simulation include one or more secondary image instructions to display secondary images related to the simulation.

9. The computer program product of claim 8, wherein said secondary images are selected from a group of secondary images comprising hand signal images and retired gunner images.

10. The computer program product of claim 1, wherein said computer readable program code is configured to:
provide for manual entry and editing of said high level computer instructions within a defined high level program area on the display screen prior to said translation of said high level computer instructions into said low level computer executable instructions.

11. The computer program product of claim 1, wherein said computer readable program code is configured to:
provide for said execution of the simulation at a predetermined speed; and
provide for variation of said predetermined speed.

12. The computer program product of claim 1, wherein said computer readable program code is configured to:
provide for downloading of said high level computer instructions to an external device for storage and execution on said external device.

13. The computer program product of claim 12, wherein said external device is a portable hand held device.

14. The computer program product of claim 12, wherein said external device is a remote controller device also capable of controlling one or more remote electronic training devices.

15. The computer program product of claim 1, wherein said computer readable program code is configured to:
provide for importing and display of one or more landscape images into said defined area on the display screen.

16. A computer program product for developing and directing a simulation displayable on a display screen, the computer program product embodied on a computer usable medium, the computer program product comprising:
computer readable program code configured to:
provide for selection of multiple locations within a defined area on the display screen;
provide for automatic creation of one or more high level computer instructions describing the simulation relative to said locations following selection of one or more high level commands from a high level command area on the display screen and one or more high level actions from a high level action area on the display screen; and
provide for translation of said one or more high level computer instructions into low level computer executable instructions necessary to carry out execution of the simulation.

17. A method for developing and directing a simulation displayable on a display screen comprising the steps of:
running a computer program product on a computer connected to the display screen, said computer program product designed for developing and directing simulations;
using said computer program product to select multiple locations within a defined area on the display screen;
using said computer program product to select one or more high level commands from a high level command area on the display screen;
using said computer program product to select one or more high level actions from a high level action area on the display screen; and
using said computer program product to automatically combine said selected one or more high level commands and said selected one or more high level actions to create one or more high level computer instructions describing the simulation relative to said locations.

18. The method of claim 17, including the step of using said computer program product to translate said one or more high level computer instructions into low level computer executable instructions necessary to carry out execution of the simulation.

19. The method of claim 17, wherein said one or more high level computer instructions describing the simulation include (a) character instructions assigning object character to one or more of said locations, and (b) movement instructions assigning object movement between two or more of said locations.

20. The method of claim 17, wherein said one or more high level computer instructions describing the simulation are selected from a group of high level computer instructions consisting of: one or more sound instructions describing one or more sounds related to the simulation, one or more speed control instructions to control the speed of said execution of the simulation, one or more delay instructions to delay said execution of the simulation, one or more comment instructions to insert textual comments into the simulation, one or more secondary image instructions to display secondary images related to the simulation, and combinations thereof.

21. The method of claim 17, including the step of using said computer program product to import and display one or more landscape images into said defined area on the display screen.

22. The method of claim 17, including the step of downloading said high level computer instructions to an external device, wherein said external device has been configured to translate said one or more high level computer instructions into low level computer executable instructions necessary to carry out execution of the simulation.

23. The method of claim 22, wherein said external device is a portable handheld device.

24. The method of claim 22, wherein said external device is a remote controller device also capable of controlling one or more remote electronic training devices.
